(19) United States
(12) Patent Application Publication
(10) Pub. No.: US 2012/0126143 A1
(43) Pub. Date: May 24, 2012

(54) APPARATUS AND METHOD FOR OPERATING OPTICAL MICROCAVITY BY LIGHT EMITTING DIODE

(75) Inventor: Michael Himmelhaus, Berlin (DE)

(73) Assignee: FUJIREBIO INC., Tokyo (JP)

(21) Appl. No.: 13/378,752

(22) PCT Filed: Jun. 2, 2010
(86) PCT No.: PCT/JP2010/059730

§ 371 Date: Feb. 1, 2012

Related U.S. Application Data
(60) Provisional application No. 61/218,260, filed on Jun. 18, 2009.

(51) Int. Cl. G01N 21/64

(52) U.S. Cl. 250/459.1; 250/458.1; 250/226

(57) ABSTRACT

An optical cavity mode apparatus comprising at least one microresonator; a light emitting diode for supplying light irradiation to the microresonator to stimulate the excitation level of the microresonator; and an optical detector to obtain spectra of the microresonator stimulated by the light emitting diode.

### CROSS REFERENCE TO RELATED APPLICATION

The present application claims all benefits accruing under 35 U.S.C. §365(c) from the PCT International Application PCT/JP2010/059730, with an International Filing Date of Jun. 2, 2010, which claims the benefit of U.S. provisional patent application No. 61/218,260 filed in the US Patent and Trademark Office on Jun. 18, 2009, the entire contents of which are incorporated herein by reference.

### BACKGROUND

1. Technical Field

The present invention relates to a technology related to an optical sensor based on optical cavity mode excitations in microresonators.

U.S. provisional patent application No. 60/796,162 filed on May 1, 2006, PCT application No. PCT/JP2007/059,443 filed on Apr. 26, 2007 and lately published as WO2007129682, U.S. provisional patent application No. 61/018,144 filed on Dec. 31, 2007, U.S. patent application Ser. No. 11/918,944 filed on May 15, 2007 and U.S. provisional patent application No. 61/140,790 filed on Dec. 24, 2008 are incorporated by reference herein for all purposes.

2. Background Art

Optical microresonators confine light to small volumes by resonant recirculation and have demonstrated potential use as microscopic light emitters, lasers, and sensors (K. J. Vahala, Nature 424, pp. 839-846, 2003). The recirculation imposes geometry-dependent boundary conditions on wavelength and propagation direction of the light kept inside the microresonators. Accordingly, only certain optical modes, the so-called “cavity modes”, can be populated. Since the energy levels of these allowed modes depend crucially on geometry and optical properties of the microresonators, the latter include very sensitive microscopic optical sensors that can be used for example to sense forces (e.g. by deformation of the cavity (M. Gerlach et al., Optics Express 15, 6, pp. 3597-3606, 2007)) or changes in chemical concentration (e.g. by a corresponding change of the refractive index in close vicinity of the microresonators). Similarly, microresonators can be used for biomolecular detection, e.g. by absorption of specifically binding molecules to or into a microresonator and detecting the resultant change of the refractive index around or inside of the cavity.

In this aspect of the technology Poetter et al. (PCT/AU2005/000748, 2005) have used microresonators decorated with fluorescent labels, such as chemical fluorophores, dyes, and quantum dots for excitation of whispering gallery modes (WGM). For excitation of the fluorescent labels, they suggest the application of laser sources, and/or 100 W mercury arc lamps. While they mention that—in principle—quantum dots may be excited by LEDs, they seem not to believe that such low power excitation can be successfully applied to WGM excitation.

An inventor of the present application, Himmelhaus, described cavity mode excitation of fluorescent non-metallic particles encapsulated in a metallic coating (WO 2007129682 (A1)). He mentioned the possibility of applying “high-power LEDs” as excitation sources for cavity mode excitation indicating that also in this case it is believed that cavity mode excitation needs a certain optical excitation power for the observation of cavity modes.

It actually was a common understanding that pumping of the energy levels of the fluorescent label with a LED could not provide sufficient excitation to observe fluorescent light emission from cavity modes practically. This level of the related art did prevent those skilled in this art from applying LEDs as an excitation sources for cavity mode excitation.

### SUMMARY

The inventor of the present invention has found that the threshold for providing observable optical cavity modes in fluorescently doped microcavities could be much lower than expected and that the modes can also be excited and detected by applying commercially available light emitting diodes (LEDs) as light sources for excitation of the fluorescent material despite of their disadvantages compared to lasers as excitation sources.

At least one or more of the embodiments of the present invention has been achieved in order to solve the problems which may occur in the related arts mentioned above.

One aspect of the present invention is an optical cavity mode apparatus including at least one microresonator; a light emitting diode for supplying light irradiation to the microresonator to stimulate the optical excitation of the microresonator; and an optical detector to obtain spectra of the microresonator stimulated by the light emitting diode.

Another aspect of the present invention is a method for sensing a target object using optical mode excitations in at least one microresonator, including the steps of: preparing the microresonator; exciting the microresonator by the irradiation of a light emitting diode to obtain spectra of the microresonator; and obtaining spectra of the microresonator stimulated by the light emitting diode.

### BRIEF DESCRIPTION OF DRAWINGS

FIG. 1 shows a single microresonator or a cluster as an aggregate of microresonators optionally containing a fluorescent material for excitation of optical cavity modes in the microresonator or cluster of microresonators: (a) a single microresonator without a coating; (b) a single microresonator with a coating for achievement of wanted optical properties; (c) a cluster as an aggregate of microresonators without a coating; (d) a cluster as an aggregate of microresonators which are coated in such a way that each cavity is individually coated; and (e) a cluster as an aggregate of microresonators which are coated in such a way that neighboring cavities form optical contacts with each other;

FIG. 2 illustrates different ways of evanescent field coupling between a microresonator and an optical coupler for excitation and detection of optical cavity modes; (a) coupling via an eroded optical fiber; (b) coupling via a prism surface operated in total internal reflection; (c) coupling via the non-uniform field of a focused laser beam;

FIG. 3 shows a comparison of the fluorescence emission obtained from two different microbeads; (a) spectra obtained from a microbead with optical cavity mode excitations; (b) spectra obtained from a microbead without optical cavity mode excitations;

FIG. 4 shows the relative spectral emission characteristics (normalized to unity) in Example 3 for WGM excitation; (I) spectral emission characteristics of laser emission and Nile-red absorption; (II) spectral emission characteristics of LED emission and Nile-red absorption; wherein, (a) indicates the relative spectral absorption (normalized to unity) of Nile red for comparison, (b) indicates the spectral emission (normalized to unity) of the laser, (c) indicates the spectral emission (normalized to unity) of the LED, and (b′) indicates the position of the laser emission (b) in graph (II);

FIG. 5 shows WGM spectra obtained from a 15 μm Nile red-doped polystyrene bead immersed in PBS buffer using; (a) spectra obtained with a laser and (b) spectra obtained with a LED, and

FIG. 6 shows WGM spectra obtained from the bead studied in FIG. 5, whereby this time for detection a highly resolving 2400 lines/mm grating was applied; (I) overview over total spectral range acquired; (II) close-up of the peak around 603 nm, wherein (a) indicates spectra obtained with a laser, (b) indicates spectra obtained with a LED.

### DETAILED DESCRIPTION

Exemplary embodiments relating to the present invention will be explained in detail below with reference to the accompanying drawings.

### (i) DEFINITION OF TERMS

C6G: Coumarin 6 laser grade

FPM: Fabry-Perot mode

LED: Light emitting diode

PBS: Phosphate buffered saline

PS: Poly(styrene)

Q-Factor: Quality factor

TIR: Total internal reflection

TE: Transverse electric optical mode

TM: Transverse magnetic optical mode

WGM: Whispering gallery mode

Reflection and transmission at a surface: In general, the surface of a material has the ability to reflect a fraction of impinging light back into its ambient, while another fraction is transmitted into the material, where it may be absorbed in the course of its travel. In the following we call the power ratio of reflected light to incident light the “Reflectivity” or “Reflectance”, R, of the ambient/material interface (or material/ambient interface). Accordingly, the power ratio of transmitted light to incident light is called the “Transmittance”, T, of this interface. Note, that R and T both are properties of the interface, i.e. their values depend on the optical properties of both, the material and its ambient. Further, they depend on the angle of incidence and the polarization of the light impinging onto this interface. Both R and T can be calculated by means of the Fresnel equations for reflection and transmission.

Optical cavity: An optical cavity is a closed volume confined by a closed boundary area (the “surface” of the cavity), which is highly reflective to light in the ultraviolet (UV), visible (vis) and/or infrared (IR) region of the electromagnetic spectrum. Besides its wavelength dependence, the reflectance of this boundary area may also be dependent on the incidence angle of the light impinging on the boundary area with respect to the local surface normal. Further, the reflectance may depend on the location, i.e. where the light impinges onto the boundary area. The inner volume of the optical cavity may consist of vacuum, air, or any material that shows high transmission in the UV, visible, and/or IR. In particular, transmission should be high at least for a part of those regions of the electromagnetic spectrum, for which the surface of the cavity shows high reflectance. An optical cavity may be coated with a material different from the material of which the optical cavity is made. The material used for coating may have, e.g., different optical properties, such as different refractive index or absorption coefficient. Further it may include different physical, chemical, or biochemical properties than the material of the optical cavity, such as different mechanical strength, chemical inertness or reactivity, and/or antifouling or related biofunctional functionality. In the following, this optional coating is referred to as “shell”, while the optical cavity is called “core”. Further, the total system, i.e. core and shell together, are referred to as “(optical) microresonator”. The latter term is also used to describe the total system in the case that no shell material is applied. In addition to the shell discussed here, a part of the surface of the microresonator may be coated with additional layers (e.g. on the top of the shell) as a part of the sensing process, for example to provide a suitable biofunctional interface for detection of specific binding events or in the course of the sensing process when target molecules adsorb on the resonator surface or a part of it.

An optical cavity (microresonator) is characterized by two parameters: First, its volume V, and second, its quality factor Q. In the following, the term “optical cavity” (“microresonator”) refers to those optical cavities (microresonators) with a quality factor Q>1. Depending on the shell material used, the light stored in the microresonator may be stored in the optical cavity solely, e.g. when using a highly reflective metal shell, or it may also penetrate into the shell, e.g. when using a dielectric or semiconducting shell. Therefore, it depends on the particular system under consideration, which terms (volume and Q-factor of the optical cavity or those of the microresonator) are more suitable to characterize the resulting optical properties of the microresonator.

Quality factor: The quality factor (or “Q-factor”) of an optical cavity is a measure of its potential to trap photons inside of the cavity. It is defined as

$$Q = \frac{stored energy}{loss per roundtrip} = \frac{{ω}_{m}}{{Δω}_{m}} = \frac{{λ}_{m}}{{Δλ}_{m}} \qquad ( 1 )$$

where ωₘ and λₘ are the frequency and wavelength of the cavity mode m, respectively, and Δωₘ and Δλₘ are the corresponding bandwidths. The latter two equations connect the Q-factor with the position and bandwidth of the optical modes inside of the cavity. Obviously, the storage potential of a cavity depends on the reflectance of its surface. Accordingly, the Q-factor may be dependent on the characteristics of the cavity modes, such as their wavelength, polarization, and direction of propagation.

Volume of an optical cavity: The volume of an optical cavity is defined as its inner geometrical volume, which is confined by the surface of the cavity, i.e. the reflective boundary area.

Optical cavity mode: An optical cavity mode or just “cavity mode” is a wave solution of the electromagnetic field equations (Maxwell equations) for a given cavity. These modes are discrete and can be numbered with an integer m due to the restrictive boundary conditions at the cavity surface. Accordingly, the electromagnetic spectrum in the presence of the cavity can be divided into allowed and forbidden zones. The complete solution of the Maxwell equations consists of internal and external electromagnetic fields inside and outside of the cavity, respectively. In the following, the term “cavity mode” refers to the inner electromagnetic fields inside the cavity unless otherwise stated. The wave solutions depend on the shape and volume of the cavity as well as on the reflectance of the boundary area, i.e. the cavity surface.

For spherical cavities, there exist two main types of solutions, for which the wavelength dependence can be easily estimated, one for light propagation in radial direction and one for light propagation along the circumference of the sphere, respectively. In the following, we will call the modes in radial direction “Fabry-Perot Modes” (FPM) due to analogy with Fabry-Perot interferometers. The modes forming along the circumference of the spheres are called “Whispering Gallery Modes” (WGM) in analogy to an acoustic phenomenon discovered by Lord Rayleigh. For a simple mathematical description of the wavelength dependence of these modes, we use the standing wave boundary conditions in the following:

$${λ}_{m} = \frac{4 {Rn}_{cav}}{m} , m = 1 , 2 , 3 , … \qquad ( 2 )$$

for FPM, which states that the electric field at the cavity surface as to vanish for all times, as is the case e.g. for a cavity with a metallic coating. For WGM, the boundary conditions yield

$${λ}_{m} = \frac{2 π {Rn}_{cav}}{m} , \qquad ( 3 )$$

which basically states that the wave has to return in phase after a full roundtrip. In both formulas, “m” is an integer and is also used for numbering of the modes, R is the sphere radius, and n_{cav} is the refractive index inside of the cavity.

Mode coupling: We define mode coupling as the interaction between cavity modes emitted by two or more microresonators that are positioned in contact with each other or in close vicinity to allow an optical contact. This phenomenon has been pointed out by S. Deng et al. (Opt. Express Vol. 12, pp. 6468-6480, 2004), who have performed simulations of mode guiding through a series of microspheres. The same phenomenon has been experimentally demonstrated by V. N. Astratov et al. (Appl. Phys. Lett. Vol. 83, pp. 5508-5510, 2004), who used a chain of non-fluorescent microspheres as a waveguide and a single fluorescent microsphere positioned at one end of the microsphere waveguide in order to couple light into the chain. They have shown that the cavity modes produced by the fluorescent microsphere under excitation can propagate along the non-fluorescent microsphere chain, which means that light can be coupled from one sphere to another. The authors relate this coupling from one microsphere to another to “the formation of strongly coupled molecular modes or crystal band structures”.

T. Mukaiyama et al. (Phys. Rev. Lett. Vol. 82, pp. 4623-4626, 1999) have studied cavity mode coupling between two microspheres as a function of the radius mismatch between the microspheres. They have found that the resulting cavity mode spectrum of the bi-sphere system is highly depending on the radius mismatch of the two microspheres. More recently, P. Shashanka et al. (Opt. Express Vol. 14, pp. 9460-9466, 2006) have shown that optical coupling of cavity modes generated in two microspheres can occur despite of a large radius mismatch (8 and 5 μm). They have shown that the coupling efficiency depends strongly on the spacing between the two microspheres and as a result, the positions of the resonant wavelengths also depend on the microsphere spacing.

Optical contact: Two microresonators are said to have an “optical contact”, if light can transmit from one resonator to the other one and vice versa. In this sense, an optical contact allows potentially for mode coupling between two resonators in the sense defined above. Accordingly, a microresonator has an optical contact with the substrate if it may exchange light with it.

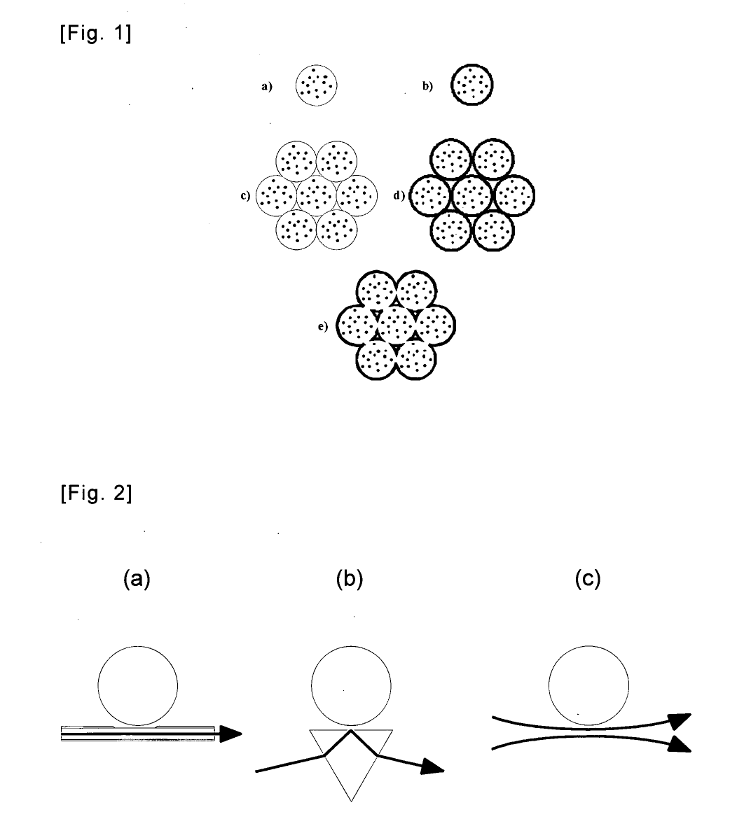

Clusters: A cluster is defined as an aggregate of cavities (microresonators) which may be either in 2 or 3 dimensions (cf. FIG. 1(c)-(e)). The individual cavities (microresonators) are either positioned in such way that they are in contact with each other or in close vicinity in order to promote the superposition of their cavity mode spectra and/or cavity mode coupling. They may be attached to a surface or float freely in a liquid medium. Further, they may be—at least temporally—detached from a surface. The individual cavities may be coated as described above in either such a way that each cavity is individually coated (FIG. 1(d)) or in such a way that neighboring cavities within a cluster form optical contacts with each other (FIG. 1(e)). The cluster may be formed randomly or in an ordered fashion for example using micromanipulation techniques, micropatterning and/or self-assembly. Further, the cluster may be formed in the course of a sensing process, for example inside of a medium, such as a live cell, after penetration of cavities (microresonators) into the medium to facilitate sensing of the wanted physical, chemical, biochemical, and/or biomechanical property. Also, combinations of all schemes shown in FIG. 1 are feasible. In general, the clusters of particles can be distributed over the surface in a random or an ordered fashion which may be either in two- or in three-dimensional structures. Thereby, photonic crystals may be formed.

Lasing threshold: The threshold for stimulated emission of a microresonator, also called the “lasing threshold”, is defined as the optical pump power of the cavity where the light amplification via stimulated emission just compensates the losses occurring during propagation of the corresponding light ray within the cavity. Since the losses for light rays traveling within a cavity mode are lower than for light rays that do not match a cavity mode, the cavity modes exhibit typically the lowest lasing thresholds (which may still differ from each other depending on the actual losses of the respective modes) of all potential optical excitations of an optical cavity. In practice, the lasing threshold can be determined by monitoring the optical output power of the cavity (e.g. for a specific optical cavity mode) as a function of the optical pump power used to stimulate the fluorescent material of the cavity (also called the “active medium” in laser physics). Typically, the slope of this dependence is (significantly) higher above than below the lasing threshold so that the lasing threshold can be determined from the intersection of these two dependencies (cf. for example A. Francois, M. Himmelhaus, Appl. Phys. Lett. Vol. 94, 031101, 2009). When talking about the “lasing threshold of an optical microresonator”, one typically refers to the lasing threshold of that optical cavity mode with the lowest threshold within the observed (utilized) spectral range. A similar definition holds accordingly for a cluster of microresonators. Here, the “lasing threshold of a cluster of optical microresonators” may be envisioned as the lasing threshold of that optical cavity mode generated in the cluster (by any of its constituting microresonators and/or any combination(s) thereof) with the lowest threshold within the observed (utilized) spectral range.

As explained above, optical microresonators confine light to small volumes by resonant recirculation and have demonstrated potential use as microscopic light emitters, lasers, and sensors. The recirculation imposes geometry-dependent boundary conditions on wavelength and propagation direction of the light kept inside the microresonators. Accordingly, only certain optical modes, the so-called “cavity modes”, can be populated. Since the energy levels of these allowed modes depend crucially on geometry and optical properties of the microresonators, the latter include very sensitive microscopic optical sensors that can be used for example to sense forces (e.g. by deformation of the microresonator) or changes in chemical concentration (e.g. by a corresponding change of the refractive index in close vicinity of the microresonators). Similarly, microresonators can be used for biomolecular detection, e.g. by adsorption and/or absorption of specifically binding molecules to or into a microresonator and detecting the resultant change of the refractive index around or inside of the cavity.

The excitation of the cavity modes inside of a microresonator is not straightforward because light with just those wavelengths, polarizations, and propagation directions, for which the resonator shows high storage potential, cannot penetrate with high efficiency into the resonator from the outside. For this reason, two different kinds of excitation schemes have been applied in the literature.

As illustrated in FIG. 2, the first scheme applies evanescent field coupling between the evanescent field of the microresonator and that of an optical coupler, such as an eroded optical fiber as shown in FIG. 2(a), a prism coupler as shown in FIG. 2(b), or a sharply focused light beam as shown in FIG. 2(c). When the evanescent fields of the two optical systems overlap, photons can tunnel through the nanometer-sized gap and thus penetrate from the optical coupler into the resonator (and vice versa). Since evanescent fields decay exponentially with increasing distance from the optical system with characteristic length scales in the optical regime of few hundreds of nanometers, this method puts some demands on the mechanical precision and stability of the coupled system. Therefore, typically not too small microresonators with the sizes of several tens of micrometers and above have been utilized. In such relatively large resonators, the free spectral range, δλ=λₘ−λₘ₊₁, where λₘ and λₘ₊₁ are two subsequent resonator modes, is very narrow and therefore difficult to resolve by means of diffractive spectroscopy. For this reason, wavelength selection is typically made by utilization of a tunable, ultra-narrow light source, such as a distributed feedback laser. Examples of this art are given, e.g., in F. Vollmer and S. Arnold, Nature Meth. Vol. 5, pp. 591-596 (2008).

Alternatively, the resonators may be excited from the interior, so that evanescent field coupling may be avoided. For example, the microresonator may be enriched with a kind of a fluorescent material, such as an organic dye, a Raman emitter, a quantum dot, a quantum well structure, and the like, which can be excited in a wavelength range λₑₓ, upon which it emits in a wavelength range λₑₘ. Then, the embedded material may be excited from the outside under those conditions that allow effective penetration of the excitation beam into the resonator. In the case of a dielectric resonator, for example, the light may impinge in perpendicular direction onto the resonator surface. Then, the light will penetrate into the resonator with typical efficiencies of >80% and thus effectively excite the fluorescent material in the interior of the resonator. The latter, however, emits its fluorescence emission in random directions, i.e. also in those with high storage potential. Thus, optical cavity modes can be excited.

This latter scheme is particularly useful for small microresonators, for which evanescent field coupling would be too tedious. Accordingly, it has been mainly applied to microresonators with sizes of few micrometers and below as given in the prior arts section.

In principle, the fluorescent material may be excited with a light source that emits in the excitation wavelength range λₑₓ of the fluorescent material. However, in practice before the present invention, mainly lasers have been applied for this purpose. There are two main reasons for this.

First of all, the microresonators are small and require an efficient excitation to become observable. Thus, tight focusing at a reasonable power density is required, which is achieved most effectively by focusing of a laser beam. Another advantage of utilization of a laser as an excitation source is its narrow bandwidth, which allows excitation of the fluorescent material where it is most efficient.

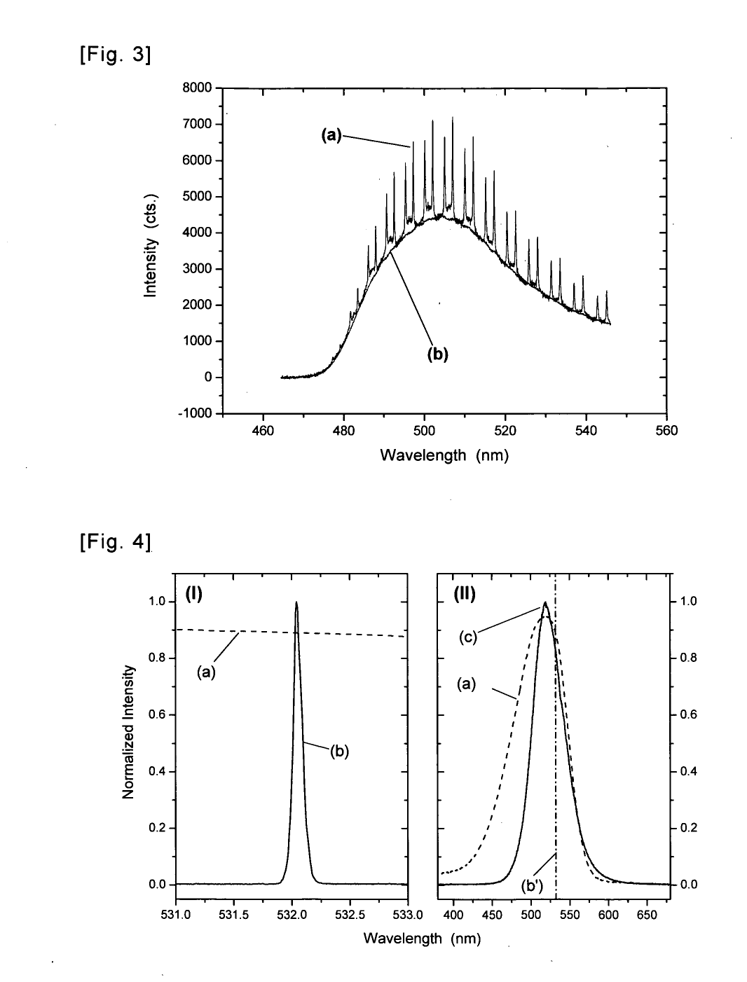

The second reason is that the modes become only observable in the fluorescence emission of the microresonator, when they are enhanced over the fluorescent background emission. Such fluorescent background originates from an excited fluorescent material inside of the microresonator, which emits into directions or at wavelengths not suited to populate cavity modes. Since this background is typically rather strong, a significant enhancement of the modes is needed for their observation. As detailed in Example 1, FIG. 3 displays the fluorescence emission spectrum of a 10 μm Coumarin 6G-doped polystyrene (PS) particle in water excited by means of a 442 nm HeCd laser. The cavity modes, which are so-called “whispering gallery modes” (WGMs) in this case, can be clearly distinguished from the overall fluorescence emission as sharp peaks. That the peaks show up in the fluorescence spectra as peaks and not as “dips” is somewhat counterintuitive, because the cavity modes have higher storage potential than other wavelengths and thus should scatter into the ambient to lesser extent. However, as explained above, a large fraction of light at cavity mode wavelengths is also scattered into the microresonator's ambient because its emission direction does not allow its trapping in a cavity mode. Therefore, if there was no additional amplification mechanism for cavity modes, the difference between fluorescence emission at cavity mode wavelength positions and other wavelength regimes would be negligible. The reason why the modes become observable as peaks of enhanced intensity is related to their higher storage potential in an indirect fashion. Because of the longer retention time of photons populating a cavity mode, the chance of such photons to induce stimulated emission of the excited fluorescent material on their path of travel inside of the micro resonator is larger than that for non-resonant photons. It is for this reason that the cavity modes become amplified. This amplification via stimulated emission, however, works obviously only if the fluorescent material inside of the microresonator is sufficiently excited. Accordingly, strong excitation using a strong optical excitation source, such as a laser, is wanted in the second scheme for cavity mode excitation and detection.

Surprisingly, however, the inventors of the present invention have found that the threshold for providing observable optical cavity modes is much lower than expected and that the modes can also be excited and detected by applying commercially available light emitting diodes (LEDs) as light sources for excitation of the fluorescent material despite of their disadvantages compared to lasers as excitation sources. In comparison to the latter, LEDs exhibit a much broader emission wavelength range, thus reducing efficiency of excitation, have lower optical output power, and—most crucially—emit into a much wider solid angle with a rather inhomogeneous beam profile. The emission is thus much less effectively optically collected and focused, and yields—accordingly—a much smaller power density on the microresonator. Therefore, it is surprising that LEDs are applicable to effective cavity mode excitation in microresonators as detailed in Examples 1-3.

### (ii) MATERIALS SECTION

The microresonators and/or clusters of microresonators of the present embodiment can be manufactured by using materials, which are available to the public. The following explanations of the materials are provided to help those skilled in the art construct the microresonators and clusters of microresonators in line with the description of the present specification.

Cavity material: Materials that can be chosen for fabrication of the cavity are those who exhibit low absorption in that part of the electromagnetic spectrum, in which the cavity shall be operated. In practice, this is a region of the emission spectrum of the fluorescent material chosen for excitation of the cavity modes. In the case of clusters of microresonators or that more than a single microresonator is used in an experiment, the different cavities involved (either constituting the cluster or those of the different single microresonators) may be made from different materials and also may be doped with different fluorescent materials, e.g. to allow their selective excitation. Also, the cavity (cavities) may consist of heterogeneous materials. In one embodiment, the cavity (cavities) is (are) made from semiconductor quantum well structures, such as InGaP/InGaAlP quantum well structures, which can be simultaneously used as cavity material and as fluorescent material, when pumped with suitable radiation. The typical high refractive index of semiconductor quantum well structures of about 3 and above further facilitates the miniaturization of the cavity or cavities because of the wavelength reduction inside of the semiconductor compared to the corresponding vacuum wavelength. In general, it is advantageous to choose a cavity material of high refractive index to facilitate miniaturization of the cavity or cavities. It is also possible to choose a photonic crystal as cavity material and to coat either the outer surface of the crystal with a fluorescent material, or to embed the fluorescent material into the crystal in a homogeneous or heterogeneous fashion. A photonic crystal can restrict the number of excitable cavity modes, enforce the population in allowed modes, and define the polarization of the allowed modes. The kind of distribution of the fluorescent material throughout the photonic crystal can further help to excite only the wanted modes, while unwanted modes are suppressed due to improper optical pumping.

An example of photonic crystals including two or three-dimensional non-metallic periodic structures that do not allow the propagation of light within a certain frequency range, the so-called “bandgap” of the photonic crystal, was shown by E. Yablonovitch (Scientific American, December issue, pp. 47-55, 2001). The light is hindered from propagation by distributed Bragg diffraction at the periodic non-metallic structure, which causes destructive interference of the differently scattered photons. If the periodicity of such a photonic crystal is distorted by a point defect, e.g. one missing scattering center in the overall periodic structure, spatially confined allowed optical modes within the bandgap may occur, similar to those localized electronic energy levels occurring within the bandgap of doped semiconductors.

In an embodiment of the present invention, the optical cavities shown have a spherical shape. Although such spherical shape is a very useful one, the cavity may in principle have any shape, such as oblate spherical shape, cylindrical, or polygonal shape given that the cavity can support cavity modes, as shown in the related art. The shape may also restrict the excitation of modes into a single or a countable number of planes within the cavity volume.

Fluorescent material: As fluorescent material, any type of material can be used that absorbs light at an excitation wavelength λ_{exc}, and re-emits light subsequently at an emission wavelength λₑₘ≠λ_{exc}. Thereby, at least one part of the emission wavelength range(s) should be located within the mode spectrum of the cavity for whose excitation the fluorescent material shall be used. In practice, fluorescent dyes, semiconductor quantum dots, semiconductor quantum well structures, carbon nanotubes (J. Crochet et al., Journal of the American Chemical Society, 129, pp. 8058-9, 2007), Raman emitters, and the like can be utilized. A Raman emitter is a material that uses the absorbed photon energy partially for excitation of internal vibrational modes and re-emits light with a wavelength higher than that of the exciting light. If a vibration is already excited, the emitted light may also have a smaller wavelength than the incoming excitation, thereby quenching the vibration (anti-Stokes emission). In any case, by proper choice of the excitation wavelength many non-metallic materials may show Raman emission, so that also the cavity materials as described above can be used for Raman emission without addition of a particular fluorescent material.

Examples of the fluorescent dyes which can be used in the present invention are shown together with their respective peak emission wavelength (unit: nm): PTP (343), DMQ (360), butyl-PBD (363), RDC 360 (360), RDC 360-NEU (355), RDC 370 (370), RDC 376 (376), RDC 388 (388), RDC 389 (389), RDC 390 (390), QUI (390), BBD (378), PBBO (390), Stilbene 3 (428), Coumarin 2 (451), Coumarin 102 (480), RDC 480 (480/470), Coumarin 307 (500), Coumarin 334 (528), Coumarin 153 (544), RDC 550 (550), Rhodamine 6G (580), Rhodamine B (503/610), Rhodamine 101 (620), DCM (655/640), RDC 650 (665), Pyridine 1 (712/695), Pyridine 2 (740/720), Rhodamine 800 (810/798), and Styryl 9 (850/830). It is necessary to have these dyes that can be excited at 320 nm and emit above 320 nm, e.g. around 450, in order to operate silver-coated microresonators (cf. e.g. WO 2007/129682).

However, for microresonators which are not coated with a silver shell, any other dye operating in the UV-NIR regime could also and/or additionally be used. Examples of such fluorescent dyes are shown: DMQ, QUI, TBS, DMT, p-Terphenyl, TMQ, BPBD-365, PBD, PPO, p-Quaterphenyl, Exalite 377E, Exalite 392E, Exalite 400E, Exalite 348, Exalite 351, Exalite 360, Exalite 376, Exalite 384, Exalite 389, Exalite 392A, Exalite 398, Exalite 404, Exalite 411, Exalite 416, Exalite 417, Exalite 428, BBO, LD 390, α-NPO, PBBO, DPS, POPOP, Bis-MSB, Stilbene 420, LD 423, LD 425, Carbostyryl 165, Coumarin 440, Coumarin 445, Coumarin 450, Coumarin 456, Coumarin 460, Coumarin 461, LD 466, LD 473, Coumarin 478, Coumarin 480, Coumarin 481, Coumarin 485, Coumarin 487, LD 489, Coumarin 490, LD 490, Coumarin 498, Coumarin 500, Coumarin 503, Coumarin 504 (Coumarin 314), Coumarin 504T (Coumarin 314T), Coumarin 510, Coumarin 515, Coumarin 519, Coumarin 521, Coumarin 521T, Coumarin 522B, Coumarin 523, Coumarin 525, Coumarin 535, Coumarin 540, Coumarin 540A, Coumarin 545, Pyrromethene 546, Pyrromethene 556, Pyrromethene 567, Pyrromethene 567A, Pyrromethene 580, Pyrromethene 597, Pyrromethene 597-8C9, Pyrromethene 605, Pyrromethene 650, Fluorescein 548, Disodium Fluorescein, Fluorol 555, Rhodamine 3B Perchlorate, Rhodamine 560 Chloride, Rhodamine 560 Perchlorate, Rhodamine 575, Rhodamine 19 Perchlorate, Rhodamine 590 Chloride, Rhodamine 590 Tetrafluoroborate, Rhodamine 590 Perchlorate, Rhodamine 610 Chloride, Rhodamine 610 Tetrafluoroborate, Rhodamine 610 Perchlorate, Kiton Red 620, Rhodamine 640 Perchlorate, Sulforhodamine 640, DODC Iodide, DCM, DCM Special, LD 688, LDS 698, LDS 720, LDS 722, LDS 730, LDS 750, LDS 751, LDS 759, LDS 765, LDS 798, LDS 821, LDS 867, Styryl 15, LDS 925, LDS 950, Phenoxazone 660, Cresyl Violet 670 Perchlorate, Nile Blue 690 Perchlorate, Nile red, LD 690 Perchlorate, LD 700 Perchlorate, Oxazine 720 Perchlorate, Oxazine 725 Perchlorate, HIDC Iodide, Oxazine 750 Perchlorate, LD 800, DOTC Iodide, DOTC Perchlorate, HITC Perchlorate, HITC Iodide, DTTC Iodide, IR-144, IR-125, IR-143, IR-140, IR-26, DNTPC Perchlorate, DNDTPC Perchlorate, DNXTPC Perchlorate, DMOTC, PTP, Butyl-PBD, Exalite 398, RDC 387, BiBuQ Stilbene 3, Coumarin 120, Coumarin 47, Coumarin 102, Coumarin 307, Coumarin 152, Coumarin 153, Fluorescein 27, Rhodamine 6G, Rhodamine B, Sulforhodamine B, DCM/Pyridine 1, RDC 650, Pyridine 1, Pyridine 2, Styryl 7, Styryl 8, Styryl 9, Alexa Fluor 350 Dye, Alexa Fluor 405 Dye, Alexa Fluor 430 Dye, Alexa Fluor 488 Dye, Alexa Fluor 500 and Alexa Fluor 514 Dyes, Alexa Fluor 532 Dye, Alexa Fluor 546 Dye, Alexa Fluor 555 Dye, Alexa Fluor 568 Dye, Alexa Fluor 594 Dye, Alexa Fluor 610 Dye, Alexa Fluor 633 Dye, Alexa Fluor 647 Dye, Alexa Fluor 660 Dye, Alexa Fluor 680 Dye, Alexa Fluor 700 Dye, and Alexa Fluor 750 Dye.

Combinations of different dyes may be used, for example with at least partially overlapping emission and excitation regimes, for example to tailor or shift the operation wavelength regime(s) of the microresonator(s).

Water-insoluble dyes, such as most laser dyes, are particularly useful for incorporation into the beads, while water-soluble dyes, such as the dyes obtainable from Invitrogen (Invitrogen Corp., Carlsbad, Calif.), are particularly useful for staining of the environment of the beads, including their surface.

Semiconductor quantum dots that can be used as fluorescent materials for doping the microresonators have been described by Woggon and co-workers (M. V. Artemyev & U. Woggon, Applied Physics Letters 76, pp. 1353-1355, 2000; M. V. Artemyev et al., Nano Letters 1, pp. 309-314, 2001). Thereby, quantum dots (CdSe, CdSe/ZnS, CdS, CdTe for example) can be applied to the present invention in a similar manner as described by Kuwata-Gonokami and co-workers (M. Kuwata-Gonokami et al., Jpn. J. Appl. Phys. Vol. 31, pp. L99-L101, 1992), who have shown that the fluorescence emission of dye molecules can be utilized for population of microresonator cavity modes. The major advantage of quantum dots over dye molecules is their higher stability against degradation, such as bleaching. The same argument holds for semiconductor quantum well structures, e.g. made from InGaP/InGaAIP, which exhibit high stability against bleaching and cannot only be used as fluorescent material but also as cavity material.

The excitation wavelength λ_{exc} of the fluorescent material does not have necessarily to be smaller than its emission wavelength λₑₘ, i.e. λ_{exc}<λₑₘ, since one also can imagine multiphoton processes, where two or more photons of a given energy have to be absorbed by the material before a photon of twice or higher energy will be emitted. Also, as mentioned above, Raman anti-Stokes processes might be used for similar purpose.

Combinations of different fluorescent materials, such as those exemplified above, may be used, for example to tailor or shift the operation wavelength regime(s) of the optical cavity (cavities) or microresonator(s). This may be achieved, for example, by suitable combination of excitation and emission wavelength regimes of the different fluorescent materials applied.

In general, the fluorescent material can be incorporated into the cavity material, adsorbed on the cavities' or microresonators' surface, and/or placed in the cavities' or microresonators' immediate environment, e.g. within the evanescent field of the cavity modes to be excited. The distribution can be used to select the type of cavity modes that are (preferably) excited. For example, if the fluorescent material is concentrated in vicinity of the core surface, whispering gallery modes are more likely to be excited than Fabry Perot modes. If the fluorescent material is concentrated in the centre of the cavity, Fabry Perot modes are easier to excite. Other examples of a heterogeneous distribution are those, in which the fluorescent material is distributed in an ordered fashion, i.e. in terms of regular two- or three-dimensional patterns of volumes with a high concentration of the fluorescent material. In such a case, diffraction effects may occur, which helps to excite the cavity in distinct directions, polarizations, and/or modes, e.g., similar to those found in distributed feedback dye lasers.

Shell: The cavities and/or the clusters of cavities or microresonators might be embedded in a shell which might have a homogeneous thickness or not. The shell may consist of any material (metal, dielectric, semiconductor) that shows sufficient transmission at least in a part of the excitation wavelength regime(s) λ_{exc} of the chosen fluorescent material(s). Also, the shell may consist of different materials with wanted properties, for example to render the surface of microresonator(s) and/or cluster(s) of microresonators transparent only at wanted locations and/or areas or—to give another example—to facilitate selective (bio-)functionalization. In the case of semiconductors, the shell becomes transparent when the excitation wavelength is higher than the wavelength corresponding to the bandgap of the considered semiconductor. For a metal, high transparency may be achieved, for example, by taking advantage of the plasma frequency of the metal, above which the conduction electrons of the metal typically do no longer contribute to the absorption of electromagnetic radiation. Among useful metals are aluminum and transition metals, such as silver, gold, copper, titanium, chromium, cobalt and the like. The shell can be continuous, as fabricated for example via evaporation or sputtering, or contiguous as often achieved by means of colloidal metal particle deposition and subsequent electroless plating (Braun & Natan, Langmuir 14, pp. 726-728, 1998; Ji et al., Advanced Materials 13, pp. 1253-1256, 2001; Kaltenpoth et al., Advanced Materials 15, pp. 1113-1118, 2003). Also, the thickness of the shell may vary from a few nanometers to several hundreds of nanometers. The only stringent requirement is that the reflectivity of the shell is sufficiently high in the wanted spectral range to allow for Q-factors with values of Q>1. For FPM in spherical cavities, the Q-factor can be calculated from the reflectance of the shell 4 (or vice versa) by the formula

$$Q = \frac{{λ}_{m}}{{Δλ}_{m}} = m π \frac{\sqrt{{R}_{sh}}}{1 - {R}_{sh}} \qquad ( 4 )$$

where Rₛₕ is the reflectance of the shell at λₘ and λₘ is the wavelength of cavity mode m.

Biofunctional coating: The microresonator(s) or clusters of microresonators may be coated with a (bio-)functional coating facilitating their (bio-)mechanical and/or (bio-) chemical function. For example, they may be functionalized with specific analytes to initiate a wanted cell response, or to facilitate biomechanical and/or biochemical sensing. For sake of brevity, the microresonators or clusters of microresonators will be called “the sensor” in the following.

To render the sensor selective for specific analytes, it is preferred to coat the sensor surface with coupling agents that are capable of (preferably reversibly) binding an analyte, such as proteins, peptides, and nucleic acids. Methods for conjugating coupling agents are well-known to those skilled in the art for various kinds of surfaces, such as polymers, inorganic materials (e.g. silica, glass, titania) and metal surfaces, and are equally suitable for derivatizing the sensor surface of the embodiment of the present invention. For example, in the case of a transition metal-coating (e.g. gold, silver, copper, titanium, chromium, cobalt, and/or an alloy and/or composition thereof), the sensor of the embodiment of the present invention can be chemically modified by using thiol chemistries. For example, the metal-coated non-metallic cores can be suspended in a solution of thiol molecules having an amino group such as aminoethanethiol so as to modify the sensor surface with an amino group. Next, biotin modified with N-hydroxysuccinimide suspended in a buffer solution of pH 7-9 can be activated by EDC, and added to the sensor suspension previously modified by an amino group. As a result, an amide bond is formed so as to modify the metal-coated non-metallic cores with biotin. Next, avidin or streptavidin including four binding sites can be bound to the biotin. Next, any biotin-derivatized biological molecule such as protein, peptide, DNA or any other ligand can be bound to the surface of the avidin-modified metal-coated non-metallic cores.

Alternatively, amino-terminated surfaces may be reacted with an aqueous glutardialdehyde solution. After washing the sensor suspension with water, it is exposed to an aqueous solution of proteins or peptides, facilitating covalent coupling of the biomolecules via their amino groups (R. Dahint et al., Anal. Chem., 1994, 66, 2888-2892). If the sensor is first carboxy-terminated, e.g. by exposure to an ethanolic solution of mercaptoundecanoic acid, the terminal functional groups can be activated with an aqueous solution of EDC and N-hydroxysuccinimide. Finally, proteins or peptides are covalently linked to the activated surface via their amino groups from aqueous solution (Herrwerth et al., Langmuir 2003, 19, 1880-1887).

In a similar fashion, also sensors coated with other metals, such as aluminum, and non-metallic sensors can be specifically functionalized. For example, aluminum can be functionalized with molecules containing carboxyl groups, which then may serve as linker groups for further biofunctionalization in a similar fashion as the thiols discussed above. Related kinds of chemistries for surface functionalization are available for a large range of metals, semiconductors, and their oxides. In analogy to the thiol chemistry described above for functionalization of transition metal surfaces, suitable kinds of coupling agents, such as amino-, mercapto-, hydroxy-, or carboxy-terminated siloxanes, phosphates, amines, carboxylic or hydroxamic acids, and the like, can be utilized for chemical functionalization of the sensor surface, on which basis then coupling of biomolecules can be achieved as described or in similar fashion as in the examples above. Suitable surface chemistries can be found in the literature (e.g. A. Ulman, Chem. Rev. Vol. 96, pp. 1533-1554, 1996 and references therein).

Another strategy of functionalizing sensors is related to the use of polymeric coatings. For example, polyelectrolytes (PE), such as PSS, PAA, and PAH, can be used as described in the literature (G. Decher, Science Vol. 277, pp. 1232ff., 1997; M. Lösche et al., Macromol. Vol. 31, pp. 8893ff., 1998) to achieve a sensor surface including a high density of chemical functionalities, such as amino (PAH) or carboxylic (PAA) groups. Then, for example the same coupling chemistries as described above can be applied to these PE coated sensors. This technique is in general applicable to all kinds of sensors with metallic or non-metallic surface, possibly in combination with a suitable coupling agent as those given above.

A general problem in controlling and identifying biospecific interactions at surfaces and particles is non-specific adsorption. Common techniques to overcome this obstacle are based on exposing the functionalized surfaces to other, strongly adhering biomolecules in order to block non-specific adsorption sites (e.g. to BSA). However, the efficiency of this approach depends on the biological system under study and exchange processes may occur between dissolved and surface bound species. Moreover, the removal of non-specifically adsorbed biomolecules may require copious washing steps, thus, preventing the identification of specific binding events with low affinity.

A solution to this problem is the integration of the coupling agents into inert materials, such as coatings of poly- (PEG) and oligo(ethylene glycol) (OEG). The most common technique to integrate biospecific recognition elements into OEG-terminated coatings is based on co-adsorption from binary solutions, composed of protein resistant EG molecules and a second, functionalized molecular species suitable for coupling agent coupling (or containing the coupling agent itself). Alternatively, also direct coupling of coupling agent to surface-grafted end-functionalized PEG molecules has been reported.

Recently, a COOH-functionalized poly(ethylene glycol) alkanethiol has been synthesized, which forms densely-packed monolayers on gold surfaces. After covalent coupling of biospecific receptors, the coatings effectively suppress non-specific interactions while exhibiting high specific recognition (Herrwerth et al., Langmuir 2003, 19, pp. 1880-1887).

The binding entities immobilized at the surface may be proteins such as antibodies, (oligo-)peptides, oligonucleotides and/or DNA segments (which hybridize to a specific target oligonucleotide or DNA, e.g. a specific sequence range of a gene, which may contain a single nucleotide polymorphism (SNP), or carbohydrates). To reduce non-specific interactions, the binding entities will preferably be integrated in inert matrix materials.

Position control functionality: The sensors of embodiments of the present invention may be utilized as remote sensors and therefore may require control of their positions and/or movements by external means, for example to control their contact and/or interaction with a selected target, such as a cell. Such control may be achieved by different means. For instance, the sensors may be rendered magnetic and electromagnetic forces may be applied to direct the sensor(s) (C. Liu et al., Appl. Phys. Lett. Vol. 90, pp. 184109/1-3, 2007). For example, paramagnetic and super-paramagnetic polymer latex particles containing magnetic materials, such as iron compounds, are commercially available from different sources (e.g. DynaBeads, Invitrogen Corp., or BioMag/ProMag microspheres, Polysciences, Warrington, Pa.). Because the magnetic material is embedded into a polymeric matrix material, which is typically made of polystyrene, such particles may be utilized in the same or a similar way as optical cavity mode sensors as the non-magnetic PS beads described in the examples below. Alternatively or in addition, a magnetic material/functionality may be borne by the shell of the microresonator(s) and/or their (bio-)functional coating.

Further, the position control may be mediated by means of optical tweezers (J. R. Moffitt et al., Annu. Rev. Biochem. Vol. 77, pp. 205-228, 2008). In such case, the laser wavelength(s) of the optical tweezers may be either chosen such that it does or that it does not coincide with excitation and/or emission wavelength range(s) of the fluorescent material(s) used to operate the sensor. For example, it might be desirable to use the optical tweezers' operating wavelength also for (selective) excitation of (one of) the fluorescent material(s). One advantage of optical tweezers over magnetic tweezers would be that a number of different sensors may be controlled individually at the same time (C. Mio et al., Rev. Sci. Instr. Vol. 71, pp. 2196-2200, 2000).

In other schemes, position and/or motion of the sensors may be controlled by acoustic waves (M. K. Tan et al., Lab Chip Vol. 7, pp. 618-625, 2007), (di)electrophoresis (S. S. Dukhin and B. V. Derjaguin, “Electrokinetic Phenomena”, John Wiley & Sons, New York, 1974; H. Morgan and N. Green, “AC Electrokinetics: colloids and nanoparticles”, Research Studies Press, Baldock, 2003; H. A. Pohl, J. Appl. Phys. Vol. 22, pp. 869-671, 1951), electrowetting (Y. Zhao and S. Cho, Lab Chip Vol. 6, pp. 137-144, 2006), and/or by a microfluidics device that potentially may also be capable of sorting/picking particles and/or cells of desired dimension and/or function (S. Hardt, F. Schönfeld, eds., “Microfluidic Technologies for Miniaturized Analysis Systems”, Springer, New York, 2007).

Also mechanical tweezers may be utilized for position control of the sensor(s), for example by employing a microcapillary capable of fixing and releasing a particle via application of pressure differences (M. Herant et al., J. Cell Sci. Vol. 118, pp. 1789-1797, 2005). The beauty of this approach is that for example in cell sensing experiments, sensors and cells may be manipulated using the same instrumentation (cf. M. Herant et al.). Also combinations of two or more of the schemes described above may be suitable for position control of sensor(s) and/or target(s).

Excitation light source: For excitation of (a) microresonator(s) or cluster(s) of microresonators, a LED has to be chosen such that its emission falls at least partially into the excitation frequency range ω_{exc} of (at least one of) the fluorescent material(s) applied. The emission power should be such that it can overcompensate the losses (radiation losses, damping, absorption, scattering) that may occur in the course of excitation of the microresonators. If several fluorescent materials are utilized with suitably chosen, e.g. non-overlapping or partially overlapping, excitation frequency ranges, more than a single LED may be chosen such that individual microresonators or clusters of microresonators may be addressed selectively, e.g. to further facilitate the readout process or for the purpose of reference measurements. For example, it may be desirable to address only a single microresonator within a cluster. Further, the excitation power of at least one of the LEDs may be chosen such that at least one of the microresonator(s) or cluster(s) of microresonators utilized is/are operated—at least temporally—above the lasing threshold of at least one of the optical cavity modes excited.

Detection of fluorescence emission: For detection of the radiation emitted by the fluorescent material in vicinity of the microresonator(s) or clusters of microresonators, any kind of light collection optics known to those skilled in the art may be utilized. For example, the emission can be collected by a microscope objective of suitable numerical aperture and/or any other kind of suitable far-field optics, by an optical fiber, a waveguide structure, an integrated optics device, the aperture of a near field optical microscope (SNOM), or any suitable combination thereof. In particular, the collection optics may utilize far-field and/or near-field aspects for detection of the signal. Then, the collected light can be analyzed by any kind of suitable spectroscopic apparatus. For example, confocal fluorescence microscopes combine fluorescence excitation via laser light with collection of the fluorescence emission with high numerical aperture, followed by filtering and spectral analysis of the fluorescence emission. Since such instruments are often used in biochemical and biological studies, they may provide a convenient tool for implementation of the present invention. Other convenient instruments are, for example, Raman microscopes, which also combine laser excitation and high numerical aperture collection of light signals from microscopic sources with spectral analysis. Further, both kinds of instruments allow simultaneous spectral analysis and imaging, which facilitates tracing of the microresonator position(s) in the course of their operation. If such imaging information is not required, also other kinds of devices, such as fluorescence plate readers, may be applicable.

### (iii) EMBODIMENTS

Embodiments of the present invention will be explained hereinafter.

An optical sensor in the embodiments includes a single microresonator, an assembly of microresonators, arrays of microresonators, clusters of microresonators or arrays of clusters of microresonators. The cavity mode(s) of the microresonator or the microresonators is (are) excited under or above the lasing threshold by means of a suitable LED as an excitation source.

Another embodiment of the present invention includes the microresonators which are excited by a LED for generation of optical cavity modes in liquid environment. In a liquid environment, the number of observable cavity modes is reduced as compared to an air environment, thereby facilitating detection, tracing, and/or excitation of the remaining modes.

### (iv) WORKING EXAMPLES

### Example 1

### Amplification of Cavity Modes Via Stimulated Emission

In this example, we demonstrate that optical cavity modes generated in fluorescent microresonators via excitation of the fluorescent material show an enhancement in the fluorescence emission spectra of the microresonator as compared to other, i.e. non-resonant, emission wavelengths.

Materials & Methods. A drop of suspension of C6G-doped PS microbeads (Polysciences, Inc., Warrington, Pa.) with a nominal diameter of 10 μm was placed on a glass microscopy cover slip. The sample was mounted onto the sample stage of a Nikon TS100 inverted microscope, which was used for observation and selection of suitable microbeads as well as their excitation and detection. For excitation, a cw-HeCd laser (Kimmon Lasers, Tokyo, Japan) operating at 442 nm was applied. The laser power at the microscope objective used for excitation and detection (Nikon, 100×) was 24.7 μW with a focus of about 20 μm. For detection of the fluorescence emission of the microbeads, the light was guided through the camera port of the microscope to the entrance slit of a high-resolution monochromator (Horiba Yobin-Ivon Triax 550, 600 L/mm grating, width of entrance slit 10 μm) equipped with a cooled CCD camera (Andor Technologies, Belfast, model DU-440 BU). Acquisition settings were 1 s exposure time, 20 accumulations. For further details, we refer to the literature (A. Francois, M. Himmelhaus, Appl. Phys. Lett. 94, 031101 (2009)).

Results. FIG. 3 displays two spectra (a) and (b), which were obtained from two different microbeads, the first spectra (a) from a microbead with spherical shape, thereby allowing the excitation of optical cavity modes, the second spectra (b) from a microbead with an odd shape and thus suppressing the excitation of optical cavity modes. Spectrum (a) is shown as obtained by the CCD camera, while spectrum (b) has been scaled to match the overall lineshape of the fluorescence emission of spectrum (a), in particular in those regions where no modes are observable. This was necessary because the absolute fluorescence intensity of two different particles may vary depending on their size and dye content. It can be seen, however, that after this renormalization, the lineshape of spectrum (b) follows exactly that of the non-resonant parts of spectrum (a), while the resonant modes are enhanced over this non-resonant background. The reason for this enhancement of the optical cavity modes over the non-resonant background fluorescence is related to the longer storage times for photons populating these modes, which increases the probability of stimulated emission into the mode and thus to an enhancement. Because of this need for stimulated emission for the visualization of optical cavity modes in fluorescence spectra, it has been thought that the fluorescent material needs to be excited above a certain threshold, thereby favoring its excitation by means of lasers as excitation sources.

### Example 2

### Comparison of Beam Characteristics of Laser and LED

In this example, the beam characteristics of the light sources used in Example 3 for excitation of WGM in fluorescently doped PS beads are compared.

The most important differences in the emission characteristics of the two sources with respect to the present embodiment are the emitted spectral range, coherence, and beam profile. While the laser (Lumera Lasers, Germany, model Rapid) emits a monochromatic, highly coherent beam with almost ideal Gaussian (TE00) profile, the LED (OptoSupply, Japan, model OSG3DA5111A-VW) sends out broadband, incoherent radiation with varying intensity distribution in different directions, yielding an irregular profile within the illuminated solid angle. These properties of LED emission make light collection, guidance, and in particular focusing a difficult task, not least because of the chromatic and spatial aberrations of optical systems typically used for such purpose. In contrast, the laser emission can be easily guided and focused due to the extremely low divergence of a Gaussian-shaped, monochromatic, and coherent beam. The most important properties of the two sources are listed in Table 1 for comparison.

The spectral emission characteristics are shown in FIG. 4. In this figure, (I) is from laser emission and Nile-red absorption; and (II) is from LED emission and Nile-red absorption. The relative spectral emission characteristics (normalized to unity) in Example 3 for WGM excitation are shown. FIG. 4 (I) shows spectral emission characteristics of laser emission and Nile-red absorption and FIG. 4 (II) shows spectral emission characteristics of LED emission and Nile-red absorption. For comparison the relative absorption (normalized to unity) of Nile red is plotted in both graphs (a); and (b′) indicates the position of the laser emission (b) in (II).

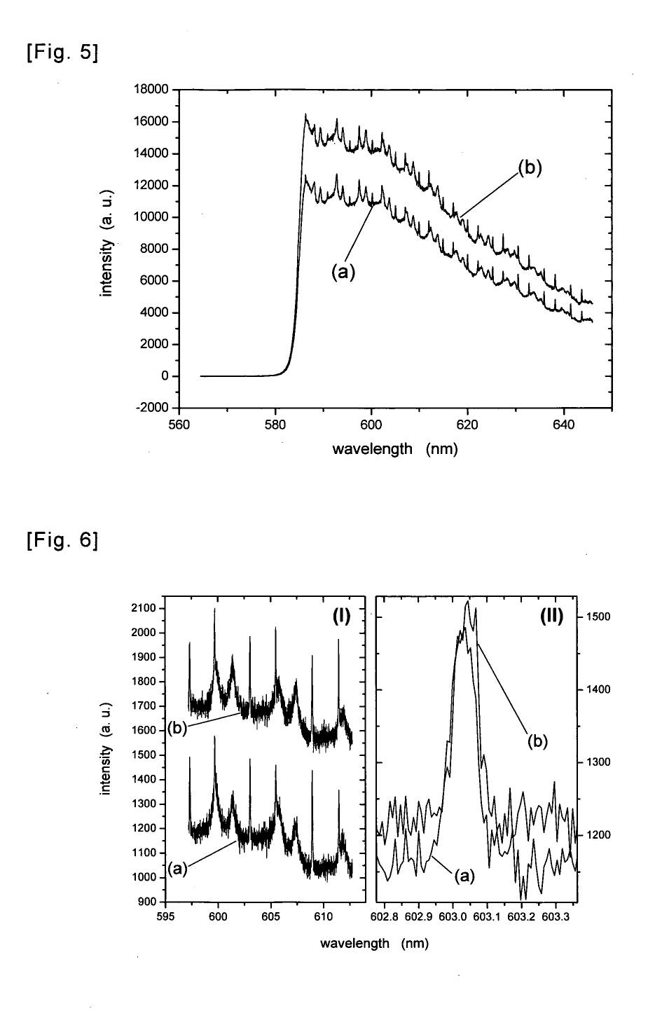

Due to this difference in optical transformation behavior, the laser can be easily focused onto the sensor by means of a microscope objective (Nikon 100×) yielding a focus diameter of about 30 μm, while the LED radiation illuminates the entire free aperture of the optical path used. Accordingly, the intensity available for excitation of the microscopic sensor is much lower than in the case of the laser. Since also the total optical emission power of the LED is significantly lower than that of the laser, the power cannot be sufficiently raised to compensate the larger beam size on the sample. Therefore, in Example 3, the laser power is severely lowered to give an intensity on the sensor similar to that of the LED, thereby allowing a direct comparison of WGM excitation by means of the two different sources. In practice, the laser intensity was lowered such that an arbitrarily chosen microbead gave similar fluorescence intensity with both LED and laser excitation (cf. FIG. 5).

TABLE 1

| Parameter | Laser | LED |
|---|---|---|
| Wavelength | (532.0 ± 0.04) nm | (519.3 ± 20.9) nm |
| Optical power (max) | 220 mW (at 10 kHz) | 5 mW |
| Temporal behavior | Pulsed | Continuous |
| Pulse duration | 9 ps | — |
| Pulse repetition rate | 10-500 kHz | — |
| Coherence | Coherent | Non-coherent |
| Beam diameter at | 320 μm | 5 mm |
| source exit | | |
| Beam profile | TEM00 | Irregular |
| Divergence full angle | 2.3 mrad | 280 mrad |
| Focus on sample | ~30 μm | >200 μm (≈field of |
| | | view) |

In addition to the intricacies of light collection and guidance, the broader spectral range of the LED also affects the dye excitation as can be seen from FIG. 4, where a Nile red absorption curve normalized to unity is plotted in the same graphs as the emission profiles of the two sources. Despite the fact that the LED emission was chosen such to match the peak absorption of the dye, its higher wavelength flank does only little contribute to dye excitation because of the rapidly dropping dye absorption in this regime. Because of this, the excitation efficiency of the LED amounts to only about 77.5% of its maximum value (given a constant dye absorption of 1 across the spectral emission range of the LED), while the laser, despite the fact that it does not exactly match the maximum of the absorption curve, reaches an efficiency of 89.0% due to its extremely narrow bandwidth.

Summarizing, the emission characteristics of LEDs seem to be much less suited for utilization as light sources for WGM excitation in microscopic particles compared to the performance of lasers. Therefore, to date LEDs have not found any application in this regard.

### Example 3

### Comparison of Laser and LED as Excitation Sources for Generation of Optical Cavity Mode Spectra in Fluorescent Microresonators

In this example, optical cavity mode spectra obtained from fluorescent microresonators upon excitation with a laser and a LED, respectively, will be compared with each other.

Materials & Methods. A small droplet (˜10 μl) of suspension of Nile red-doped PS microbeads (Polysciences, Inc., Warrington, Pa.) with a nominal diameter of 15 μm was placed on a glass microscopy cover slip, laterally confined by means of a viton sealing, and covered with a piece of fused silica glass after the void volume had been filled with PBS buffer solution. The sample was attached to the Nikon inverted microscope as in Example 1. For WGM excitation, the two light sources discussed in detail in Example 2 were applied, which are (i) a Nd:YAG picosecond laser (Lumera Lasers, model Rapid) with a pulse repetition rate of 500 kHz and a pulse duration of 9 ps and (ii) a green LED (OptoSupply, model OSG3DA5111A-VW). The light beams of the two sources were overlapped spatially and aligned such that they could be coupled alternatively into the microscope by simply switching a single mirror. Because of the poor focusing behavior of the LED as well as its low overall emission power, LED excitation of the same bead was much weaker than with the laser. The laser power was therefore reduced by means of neutral density glass filters in such a way that the overall fluorescence emission detected from a probe bead (as a microresonator) had similar intensity independent of the light source used for excitation. This was achieved at a laser power at the microscope objective (Nikon, 100×) of 0.11 μW, while that of the LED was 10.8 μW under these conditions. This difference in total power was due to the different spot size (cf. Example 2) of the two light beams. For detection, the set-up used in Example 1 was applied, this time in addition to the 600 lines/mm grating also with a highly resolving holographic 2400 lines/mm grating. The width of the monochromator entrance slit was kept constant at 10 μm. Acquisition settings were 20 s exposure time, full vertical binning, single acquisition.

Results. WGM spectra obtained of a 15 μm Nile-red doped PS bead immersed in PBS buffer and excited alternatively with radiation of one of the two light sources are shown in FIGS. 5 and 6. In FIG. 5, the 600 lines/mm grating was applied for collection of overview spectra. The sudden intensity drop on the short wavelength side of the spectra is caused by the color filter used for suppression of the excitation light. The WGM spectrum obtained with the LED as shown in FIG. 6(b) has somewhat higher intensity compared to that obtained with the laser shown in FIG. 6(a), indicating that the power adjustment was not perfect here, otherwise the spectra look basically identical and the variety of modes are nicely resembled.

In FIG. 6, the same bead is studied, this time however with the highly resolving 2400 lines/mm grating. In FIG. 6(I), which shows the full spectral range acquired, the spectrum obtained with LED excitation (b) has been slightly vertically displaced for clarity. Again, the spectral features in the two spectra match very nicely, and, as can be seen in the close-up of the sharp peak at 603 nm in FIG. 6(II), also the modes' bandwidth does not depend by any means on the source of excitation.

Summarizing, the experiment demonstrates that even under extremely weak excitation, WGM are discernible as peaks of enhanced intensity in the fluorescence emission spectra of fluorescently doped PS particles and that this weak excitation may be achieved with lasers or LEDs in the same way.

As it can be understood from the present embodiments and examples explained above, in comparison to lasers as a light source, LEDs exhibit a much broader emission wavelength range, thus reducing efficiency of excitation, have lower optical output power, and—most crucially—emit into a much wider solid angle with a rather inhomogeneous beam profile. The emission is thus much less effectively optically collected and focused, and yields—accordingly—a much smaller power density on the microresonator. Therefore, it is surprising that LEDs are applicable to effective cavity mode excitation in microresonators.

1. An optical cavity mode apparatus comprising:
at least one microresonator;
a light emitting diode for supplying light irradiation to the microresonator to stimulate the optical excitation of the microresonator; and
an optical detector to obtain spectra of the microresonator stimulated by the light emitting diode.

2. The optical cavity mode apparatus according to claim 1, wherein;
the microresonator is selected from a group consisting of a micro particle of an optical cavity substantially free from a fluorescent material, a micro particle of an optical cavity doped with at least one fluorescent material and a micro particle of an optical cavity whose surface is covered with at least one fluorescent material.

3. The optical cavity mode apparatus according to claim 1, wherein;
more than one microresonator is provided to constitute at least one cluster;
the light emitting diode supplies light irradiation to at least one of the microresonators to stimulate the optical excitation of the at least one of the microresonators; and
the optical detector obtains spectra of the at least one of the microresonators stimulated by the light emitting diode.

4. The optical cavity mode apparatus according to claim 3, wherein the cluster includes one kind of microresonator or a plurality of the kinds of microresonators in combination selected from a group consisting of a micro particle of an optical cavity substantially free from a fluorescent material, a micro particle of an optical cavity doped with at least one fluorescent material and a micro particle of an optical cavity whose surface is covered with at least one fluorescent material.

5. A method for sensing a target object using optical mode excitations in at least one microresonator, comprising:
preparing the at least one microresonator;
exciting the microresonator by the irradiation of a light emitting diode to obtain spectra of the microresonator; and
obtaining spectra of the microresonator stimulated by the light emitting diode.

6. The method for sensing the target object according to claim 5, wherein;
the microresonator is selected from a group consisting of a micro particle of an optical cavity substantially free from a fluorescent material, a micro particle of an optical cavity doped with at least one fluorescent material and a micro particle of an optical cavity whose surface is covered with at least one fluorescent material.

7. The method for sensing the target object according to claim 5, wherein;
more than one microresonator is provided to constitute at least one cluster;
the light emitting diode supplies light irradiation to at least one of the microresonators to stimulate the excitation level of the at least one of the microresonators; and
the optical detector obtains spectra of the at least one of the microresonators stimulated by the light emitting diode.

8. The method for sensing the target object according to claim 7, wherein the cluster includes one kind of microresonator or a plurality of the kinds of microresonators in combination selected from a group consisting of a micro particle of an optical cavity substantially free from a fluorescent material, a micro particle of an optical cavity doped with at least one fluorescent material and a micro particle of an optical cavity whose surface is covered with at least one fluorescent material.
